(19) United States
(12) Patent Application Publication
(10) Pub. No.: US 2023/0148568 A1
(43) Pub. Date: May 18, 2023

(54) TRACTION MODULE WITH ADJUSTABLE LENGTH LIMIT AND PET TRACTOR WITH TRACTION MODULE

(71) Applicant: Dong HAN, Shenzhen, Guangdong (CN)

(72) Inventor: Dong HAN, Shenzhen, Guangdong (CN)

(21) Appl. No.: 17/802,313

(22) PCT Filed: Apr. 1, 2020
(86) PCT No.: PCT/CN2020/082649

§ 371 Date: Jan. 24, 2023

(30) Foreign Application Priority Data
Mar. 25, 2020 (CN) 202010216461.8

(51) Int. Cl. A01K 27/00

(52) U.S. Cl. CPC A01K 27/004

(57) ABSTRACT

The invention discloses a traction module with adjustable length limit and a pet tractor with the traction module. The traction module comprises a module shell, a traction rope arranged in the module shell and a winding mechanism for winding the traction rope, wherein a gear shifting mechanism for limiting the pulling length of the traction rope by limiting movement of the winding mechanism is arranged on the module shell. According to the traction module, the structure of the pet tractor is improved, the gear shifting mechanism is additionally arranged, a user adjusts the gear shifting mechanism to limit the movement gear of the winding mechanism, so that the pulling length of the traction rope is accurately limited, the length of the traction rope can meet local use requirements, and convenience is provided for the user and a manufacturer.

### FIELD OF THE INVENTION

The present disclosure relates to the technical field of pet product, and, more particularly, to a traction module with an adjustable length limit and a pet tractor with the traction module.

### BACKGROUND

Currently, a plurality of families has a plurality of pets raised. In order to facilitate an activity of a pet when walking out with the pet and prevent the pet from getting lost or affecting others, an owner usually adopts a pet tractor. Inside the pet tractor, there is usually a traction rope which is telescopic. Since it is convenient to use, having a small size, the pet tractor has been widely applied.

A longer traction rope is able to ensure that a pet has a larger activity range and more activities, conducive to a healthy growth of the pet. However, different regions have a plurality of different management requirements, thus have a plurality of different limitations to a length of the traction rope. A length limit of the traction rope is usually between 1.2 meters and 1.8 meters. However, a plurality of telescopic traction ropes has a length exceeding the length limit. Although an existing tractor product has a braking structure or a locking structure, being able to control the rope length, it is still difficult to meet a plurality of requirements in different regions accurately. Based on a plurality of reasons stated above, using a product and managing the product, have generated a contradiction that, for a tractor manufacturer and a tractor seller, due to different regions having different length requirements, it is hard to satisfy different users in different regions by one product, which increases a difficulty in a production management and sale.

Therefore, the current technology needs to be improved and developed.

### BRIEF SUMMARY OF THE DISCLOSURE

According to the above described defects, the purpose of the present disclosure is providing a traction module with an adjustable length limit and a pet tractor with the traction module, in order to achieve a purpose of adjusting a pullout length of a traction rope conveniently.

A technical solution of the present disclosure to solve the technical problems is as follows:

a traction module with an adjustable length limit, comprising a module shell, a traction rope arranged in the module shell, and a winding mechanism applied to winding the traction rope, wherein the module shell has a gear shifting mechanism arranged, applied to limiting a pulling-out length of the traction rope by restricting a movement of the winding mechanism.

The traction module with the adjustable length limit, wherein, the winding mechanism comprises a roller arranged in the module shell and a coil spring arranged in the roller, an inner side of the module shell has a fixed shaft arranged, the roller is sleeved on the fixed shaft, and the traction rope is wound and arranged on the roller.

The traction module with the adjustable length limit, wherein the gear shifting mechanism comprises a gear shifting connector, a gear shifting disc assembly, and a regulation disc assembly arranged in a sequence, the gear shifting disc assembly connects to the roller through the gear shifting connector, the regulation disc assembly restricts a rolling number of the roller through the gear shifting disc assembly.

The traction module with the adjustable length limit, wherein the gear shifting disc assembly comprises a driving ring connecting to the gear shifting connector, and a plurality of driven rings arranged coaxially with the driving ring, the plurality of driven rings and the driving ring are engaged sequentially from outside to inside; the driving ring has a driving block arranged, and each of the plurality of driven rings has a driven block arranged.

The traction module with the adjustable length limit, wherein the gear shifting connector comprises a spline connected to the roller and a transmission shaft arranged on a side of the spline facing to the gear shifting mechanism, the transmission shaft is inserting and connecting to an inside of the driving ring, while the transmission shaft and the driving ring are rolling coaxially through a connection unit.

The traction module with the adjustable length limit, wherein the regulation disc assembly comprises a regulation disc body, a plurality of regulation holes arranged in the regulation disc body, and a regulation pin applied to inserting into the regulation hole, while the plurality of regulation holes are corresponding respectively to the plurality of driven blocks, the regulation pin inserts into one of the regulation holes, applied to blocking a movement of the driven block correspondingly.

The traction module with the adjustable length limit, wherein the module shell has an accommodating cavity arranged, applied to accommodating the gear shifting disc assembly, the regulation disc body is arranged covering a front end of the accommodating cavity; a middle part of the regulation disc body has a adapting hole arranged, applied to accommodating the regulation pin.

The traction module with the adjustable length limit, wherein the module shell further has a brake mechanism arranged, the brake mechanism comprises a support seat arranged on the module shell, a brake block slidably connected to the support seat, and a brake disc arranged on the roller while adapting to the brake block, and a spring is arranged between the brake block and the support seat.

The traction module with the adjustable length limit, wherein the brake block comprises a button and a clamping block arranged on the button, the clamping block is arranged at an end of the button facing to the roller, the brake disc is arranged on a side surface of the roller, the brake disc has a plurality of clamping teeth arranged adapting to the clamping block, and the plurality of clamping teeth are arranged evenly on an edge of the brake disc.

A pet tractor, wherein comprising any one of the traction modules with the adjustable length limit described above, and a tractor shell arranged covering an outside of the traction module.

All above, the present disclosure has a plurality of following beneficial effects:

the present disclosure improves a structure of the pet tractor, and adds a gear shifting mechanism. A user, by adjusting the gear shifting mechanism, limits a movement gear of the winding mechanism, thereby limits precisely a pull-out length of the traction rope, making a length of the traction rope be able to meet a local usage requirement, thus providing a convenience for users and manufacturers.

### BRIEF DESCRIPTION OF THE DRAWINGS

FIG. 1 illustrates a schematic structural diagram on a traction module in a preferred embodiment of the present disclosure.

FIG. 2 illustrates a schematic diagram on a whole structure in a preferred embodiment of the present disclosure.

FIG. 3 illustrates a schematic diagram on the whole structure in another view angle in a preferred embodiment of the present disclosure.

FIG. 4 illustrates an exploded diagram on a part of the winding mechanism in a preferred embodiment of the present disclosure.

FIG. 5 illustrates an exploded diagram on a part of the gear shifting mechanism in a preferred embodiment of the present disclosure.

FIG. 6 illustrates a schematic diagram on an assembly structure of the gear shifting mechanism in a preferred embodiment of the present disclosure.

FIG. 7 illustrates an exploded diagram on the gear shifting disc assembly in a preferred embodiment of the present disclosure.

Wherein: 100—tractor shell; 110—knob; 120—front body shell; 130—rear body shell; 200—traction rope; 300—winding mechanism; 310—roller; 311—clamping groove; 320—fixed shaft; 330—coil spring; 340—accommodating cavity; 400—gear shifting mechanism; 410—gear shifting connector; 411—spline; 412—transmission shaft; 420—gear shifting disc assembly; 421—driving ring; 422—driving block; 423—driven ring; 424—driven block; 430—regulation disc assembly; 431—regulation disc body; 432—regulation hole; 433—regulation pin; 434—adapting hole; 500—brake mechanism; 510—support seat; 520—brake block; 521—button; 522—clamping block; 530—brake disc; 531—clamping tooth; 540—spring; 600—module shell.

### DETAILED DESCRIPTION OF EMBODIMENTS

In order to make the purpose, technical solution and the advantages of the present disclosure clearer and more explicit, further detailed descriptions of the present disclosure are stated herein, referencing to the attached drawings and some embodiments of the present disclosure. It should be understood that the detailed embodiments of the disclosure described herein are used to explain the present disclosure only, instead of limiting the present disclosure. Those skilled in the art may make a plurality of modifications without any innovations to the embodiments stated herein, according to any real requirements, however, as long as they are covered by the protection range of the claims, they are protected by the patent law.

In a description of the present disclosure, it should be understood that a plurality of terms indicating an orientation or a positional relationship, including “length”, “width”, “upper”, “lower”, “front”, “rear”, “left”, “right”, “vertical”, “horizontal”, “top”, “bottom”, “inner”, “outer”, and more, are based on the orientation or the positional relationship indicated on the drawings, and they are used only for a convenience of describing the present disclosure and simplifying a description, instead of indicating or implying that the pointed device or element must have a specific orientation, be constructed and operated in a specific orientation, therefore cannot be understood as a limitation to the present disclosure.

In addition, the terms “first”, “second”, and “third” are only used for descriptive purposes only, instead of being understood as indicating or implying a relative importance or implicitly indicating a number of a plurality of indicated technical features. Thus, the features defined with “first”, “second”, and “third” may explicitly or implicitly comprise one or more of these features. In the description of the present disclosure, “a plurality” means two or more, unless otherwise specifically defined.

In the present disclosure, unless otherwise clearly specified and limited, a plurality of terms, including “installation”, “connecting”, “connection”, “fixation”, “setting” and more, should be understood in a broad sense. For example, it can be a fixed connection or it is detachably connected or integrated; it can be mechanically connected or electrically connected; it can be directly connected or indirectly connected through an intermediate medium, and it can also be an internal communication of two components or an interaction between the two components. For those ordinary skilled in the present art, the specific meaning of the terms mentioned above in the present disclosure can be understood according to a specific circumstance.

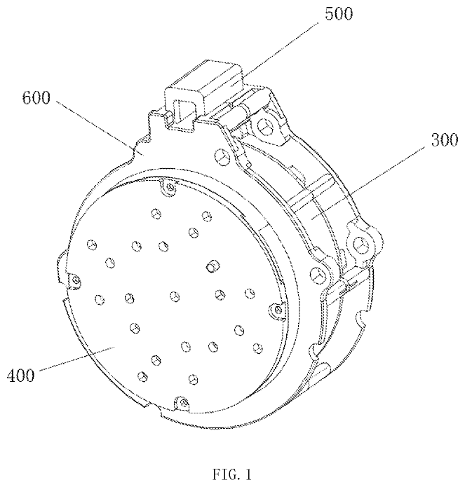

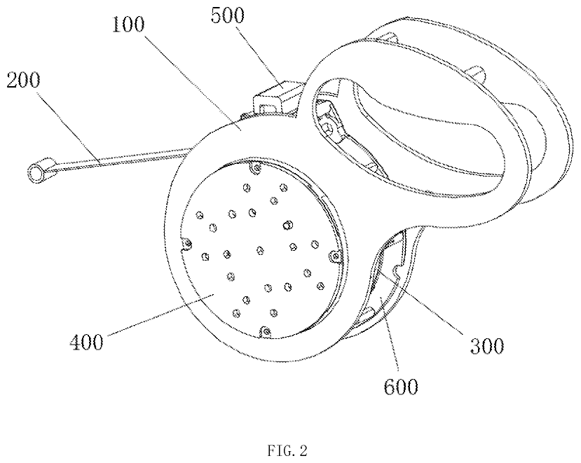

Embodiment: a traction module with an adjustable length limit, shown as FIG. 1 and FIG. 2, comprises a module shell 600, a traction rope 200 arranged in the module shell 600, and a winding mechanism 300 applied to winding the traction rope 200, preferably, a free end of the traction rope 200 has a metal hook arranged. Wherein the traction module further comprises a gear shifting mechanism 400, the gear shifting mechanism 400 is arranged on the module shell 600, the gear shifting mechanism 400 restricts a length of the traction rope 200 being able to extend, by restricting a movement of the winding mechanism 300.

Shown from FIG. 2 to FIG. 4, the winding mechanism 300 comprises a roller 310, a coil spring 330, and a fixed shaft 320. The roller 310 is arranged in the module shell 600, the coil spring 330 is arranged in the roller 310, the fixed shaft 320 is arranged on the module shell 600, and located on an inner side of the module shell 600. The roller 310 is sleeved on the fixed shaft 320, and through the fixed shaft 320, the roller 310 rolls in the module shell 600. By the fixed shaft 320 connecting to one end of the coil spring 330, it makes the coil spring 330 generate an elastic potential in contraction, and the traction rope 200 is wound and arranged on the roller 310.

When the traction rope 200 is being pulled out, the roller 310 rolls and releases the traction rope 200. Due to the coil spring 330 arranged in the roller 310, when the roller 310 rolls, it drives the coil spring 330 to deform at a same time. When an external force applied to the traction rope 200 is smaller than an elastic restoring force of the coil spring 330, the coil spring 330 will drive the roller 310 to roll reversely, thus recycling and winding the traction rope 200 onto the roller 310.

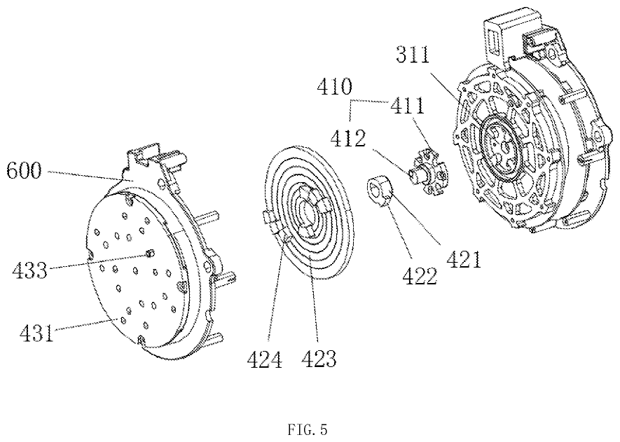

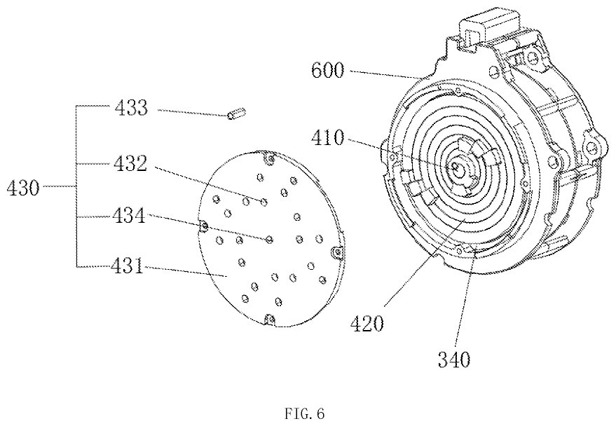

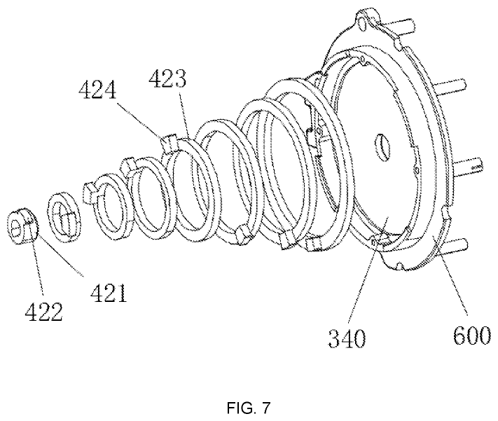

Shown from FIG. 5 to FIG. 7, the gear shifting mechanism 400 comprises a gear shifting connector 410, a gear shifting disc assembly 420, and a regulation disc assembly 430 arranged in a sequence, the gear shifting disc assembly 420 connects to the roller 310 through the gear shifting connector 410, the regulation disc assembly 430 restricts a rolling number of the roller 310 through the gear shifting disc assembly 420. The present disclosure achieves a multi-level regulation to the length of the traction rope 200, by converting a length control of the traction rope 200 into a rolling number control to the roller 310.

The present disclosure designs a gear shifting connector 410 arranged independently. Since a diameter of the roller 310 is usually much larger than a diameter of the gear shifting connector 410, thus, when towing a large pet, a large torque will be applied onto the gear shifting connector 410 when in use, and it is needed to ensure that the gear shifting connector 410 meets a strength requirement. In the prior art, the gear shifting connector 410 and the roller 310 are usually arranged integrally, in order to ensure the strength requirement of the gear shifting connector 410, the roller 310 as a whole needs to use a high-strength material. However, the present disclosure adopts a gear shifting connector 410 arranged independently, thus it is the gear shifting connector 410 only needs to adopt a high-strength material, before being able to ensure an overall structural strength, thus a material cost of the roller 310 is saved.

Specifically, the gear shifting disc assembly 420 comprises a driving ring 421 and a plurality of driven rings 423, the driving ring 421 connects to the gear shifting connector 410, and the plurality of driven rings 423 are arranged coaxially with the driving ring 421, the plurality of driven rings 423 and the driving ring 421 are nested sequentially from outside to inside; during an assembly, each of the plurality of driven rings 423 and the driving ring 421 are arranged in an order from outside to inside. The driving ring 421 has a driving block 422 arranged, and each of the plurality of driven rings 423 has a driven block 424 arranged, the driving block 422 and a plurality of the driven blocks 424 are stacked in an order from inside to outside. During working, the driving block 422 and each driven block 424 are rolling from inside to outside sequentially.

The present disclosure controls a rolling number of the roller 310 by driving or blocking each ring between each other as stated above, before achieving a length control of the traction rope 200.

Further, a side surface of the driving block 422 is perpendicular to a plane of the driving ring 421, a side surface of the driven block 424 is also arranged perpendicular to the driven ring 423, both the driving block 422 and the driven blocks 424 are arranged in a fan shape, having a center concentric with the driving ring 421. Thus, when the driving block 422 abuts against the driven block 424, and the plurality of driven blocks 424 abut against each other, they all contact in a plane, which increases a contact area, and lowers a strength requirement to a material.

The gear shifting connector 410 comprises, but not limited to, a spline 411 and a transmission shaft 412 arranged on the spline 411, the spline 411 connects to the roller 310, and a side of the roller 310 facing to the spline 411 has a clamping groove 311 arranged, applied to engaging with the spline 411, the transmission shaft 412 is arranged on a side of the spline 411 facing to the gear shifting mechanism 400. Specifically, the transmission shaft 412 is inserted and connected to an inside of the driving ring 421, while there is a connection unit arranged between the transmission shaft 412 and the driving ring 421, by the connection unit, it is achieved that the transmission shaft 412 and the driving ring 421 are rolling coaxially. Thus, when the transmission shaft 412 rolls, it will drive the driving ring 421 to roll.

Preferably, the driving ring 421 and the plurality of driven rings 423 are coated with a lubricating layer, to reduce a friction between each ring in rolling, ensuring a smooth movement of each ring when a pet stretches the traction rope 200. When recycling the traction rope 200, it ensures an elastic potential of the coil spring 330 is able to drive the roller 310, the transmission shaft 412 and each ring to return to a corresponding position smoothly.

The regulation disc assembly 430 comprises a regulation disc body 431, a plurality of regulation holes 432 arranged in the regulation disc body 431 and a regulation pin 433, the regulation pin 433 is applied to being inserted into the regulation hole 432, to limit a rolling number of the roller 310. Specifically, the plurality of regulation holes 432 are corresponding to the plurality of driven blocks 424 respectively, the regulation pin 433 is inserted into one of the regulation holes 432, applied to blocking a movement of the driven block 424 correspondingly. The module shell 600 has an accommodating cavity 340 arranged, the accommodating cavity 340 is applied to accommodating the gear shifting disc assembly 420, the regulation disc body 431 is arranged covering a front end of the accommodating cavity 340. A user achieves a gear shift of the gear shifting mechanism 400 by moving a position of the regulation pin 433, before adjusting a length limit of the traction rope 200 exactly.

In the present embodiment, when a pet moves, the traction rope 200 is forced to extend out, making the roller 310 roll in the module shell 600, thereby driving the transmission shaft 412, the driving ring 421, and the driven ring 423 to roll in an order. The driving ring 421 rolls and drives the driving block 422 to roll at a same time. During a rolling process, the driving block 422 abuts against the driven ring 423 of a first circle at the driven block 424. Then, the driven block 424 of the driven ring 423 of the first circle is driven to roll by the driving block 422, before driving the driven ring 423 of the second circle to roll. By an analogy, each driven ring 423 is driven by the driven block 424 thereof in an order until the driven block 424 of one of the driven rings 423 is blocked by the regulation pin 433 before stopping rolling.

When the driven block 424 of one of the driven rings 423 is blocked by the regulation pin 433, the present driven ring 423 and a plurality of remaining driven rings 423 in an inner circle, the driving ring 421 and the transmission shaft 412, will all stop rolling, so the roller 310 will also stop rolling, and the traction rope 200 will stop extending. All above, a position of the regulation pin 433 will control correspondingly a number of rolling of the roller 310 from an initial state, which is then converted into a rope length that the corresponding traction rope 200 is able to extend.

In an embodiment, the driven ring of the fifth circle is blocked, then all the driven rings from the first circle to the fifth circle stop moving, the driven rings of the sixth, the seventh, and the eighth cycle may generate a displacement due to a plurality of reasons including shaking, however, the displacement generated by the rings of the sixth, the seventh, and the eighth cycle will not affect a system function.

Generally, different regions define and restrict a plurality of different rope lengths, including 1.1 meters, 1.3 meters, 1.8 meters and more. In the present embodiment, there are 8 ring structures arranged, which may satisfy a requirement of controlling each length less than 1.8 meters. In a real life, if a longer length restriction is required, a more number of the ring structures may be designed.

In the present embodiment, the regulation disc assembly 430 having the regulation holes is applied as a regulation structure, the regulation pin 433 is inserted in different holes, while different holes are corresponding to different rope length gears respectively. In a specific implementation, a number and a position of the holes may be adjusted flexibly according to a real requirement.

Preferably, the regulation disc body 431 has an adapting hole 434 applied to accommodating the regulation pin 433 arranged in a middle part. When it is not needed to limit the length of the traction rope 200, the regulation pin 433 may be inserted into the adapting hole 434. Arranging the adapting hole 434 at a center of the regulation disc, which corresponds to the transmission shaft 412, thus there is no effect on anyone of the driven rings 423 rolling. Thus, the traction rope 200 can expand and contract flexibly within a maximum range of the rope length.

In an embodiment, when a length of the traction rope 200 is limited to no exceeding 1.2 meters in a city, a user inserts the regulation pin 433 into a regulation hole 432 corresponding to the 1.2 meters, and restricts the length of the traction rope 200 being able to be pulled out to 1.2 meters, meeting a local regulation. During an outing, the regulation pin 433 may be inserted into the adapting hole 434 at the center of the regulation disc, before switching to the maximum length of the rope, making the pet have a larger range of movement.

Through a plurality of technical solutions of the present disclosure described above, even if the regulation of the rope length and the restriction region are different, the user may achieve shifting the gear by a plurality of simple operations. A structure is simple and reliable. For a manufacture, by adding the gear shifting mechanism 400 onto a traditional pet tractor, a target of a set of products adapting to a variety of rope lengths is realized, so that the product may be used universally when sold in various places, and a cost of production and sales is saved.

When retracting the traction rope 200, if an external pulling force applied onto the traction rope 200 is less than a pulling force of the coil spring 330 thereof, the coil spring 330 will drive the roller 310 to roll in a reverse direction, retracting and winding the traction rope 200 onto the roller 310. When the roller 310 rolls in a reverse direction, the transmission shaft 412 drives sequentially the driving ring 421 and the plurality of driven rings 423 to roll in the reverse direction. The regulation pin 433, the driving block 422, and each of the driven blocks 424 of the present disclosure are all adopting a position avoidance setting, thus the driving ring 421 and the driven ring 423 in rolling will not touch the regulation pin. When the traction rope 200 returns from a stretched state to an initial static state, the roller 310 also stops rolling following it.

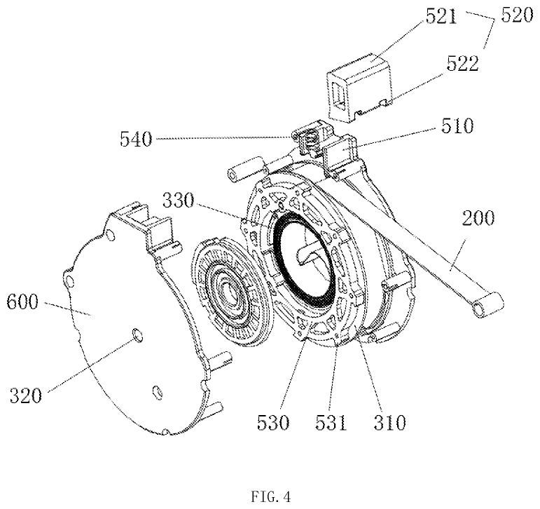

Shown as FIG. 4, the module shell 600 further has a brake mechanism 500 arranged, the brake mechanism 500 comprises a support seat 510, a brake block 520 and a brake disc 530, the support seat 510 is arranged on the module shell 600, the brake block 520 connects slidably to the support seat 510, and the brake disc 530 is arranged on the roller 310, also the brake disc 530 is adapting to the brake block 520, and a spring is arranged between the brake block 520 and the support seat 510.

The brake block 520 comprises a button 521 and a clamping block 522, the clamping block 522 is arranged on a side of the button 521 facing to the roller 310, the brake disc 530 is arranged on a side surface of the roller 310, the brake disc 530 has a plurality of clamping teeth 531 arranged adapting to the clamping block 522, and the plurality of clamping teeth 531 are arranged evenly at an edge of the brake disc 530.

Specifically, during a process of the traction rope 200 stretching and retracting, the user drives the brake block 520 to press down by pressing the button 521. At this time, a spring 540 is compressed by a force, and at a same time, the clamping block 522 abut to the clamping teeth 531 to prevent the roller 310 from rolling, making the traction rope 200 stop stretching or retracting. When the user releases the button 521, due to a spring 540 arranged between the support seat 510 and the brake block 520, the brake block 520 is reset under an elastic restoring force of the spring 540, and the clamping block 522 is separated from the clamping tooth 531, making the roller 310 be able to continue rolling, and the traction rope 200 continue to be stretched or retracted.

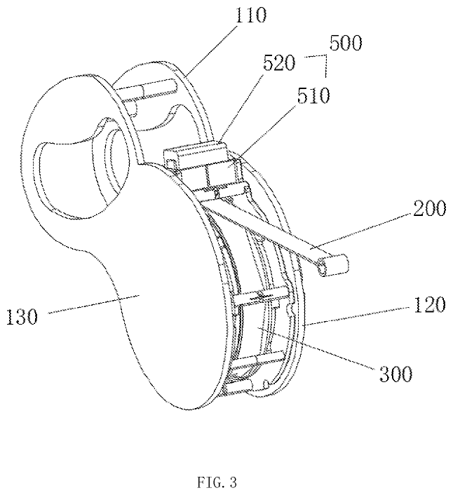

The present disclosure further provides a pet tractor, wherein shown as FIG. 2 and FIG. 3, comprising any one of the traction modules described above, and a tractor shell 100 arranged covering an outside of the traction module.

The tractor shell 100 has a knob 110 arranged, in the present embodiment, the tractor shell 100 comprises a front body shell 120 and a rear body shell 130 arranged respectively on both sides of the traction module. The front body shell 120 and the rear body shell 130 are connected fixedly by a screw or a buckle structure.

Further, shown as FIG. 3 and FIG. 4, the pet tractor further comprises a locking assembly, the locking assembly is applied to locking and stopping the brake block 520, to keep the brake block 520 at a locked stopping position, after the user releasing the button 521. Specifically, the locking assembly comprises a locking buckle that is engaged with the brake block 520. When the brake block 520 is pressed, the locking buckle and the brake block 520 are engaged automatically or manually, to keep the brake block 520 in a pressed state. It should be noted that, the locking assembly is not an emphasis protected by the present disclosure, any structures that can achieve automatically locking the brake block 520 may be applied to the present disclosure.

All above, the present disclosure improves a structure of the pet tractor, and adds a gear shifting mechanism. A user, by adjusting the gear shifting mechanism, limits a movement gear of the winding mechanism, thereby limits precisely a pull-out length of the traction rope, making a length of the traction rope be able to meet a local usage requirement, thus providing a convenience for users and manufacturers.

It should be understood that, the application of the present disclosure is not limited to the above examples listed. Ordinary technical personnel in this field can improve or change the applications according to the above descriptions, all of these improvements and transforms should belong to the scope of protection in the appended claims of the present disclosure.

What is claimed is:

1. A traction module with an adjustable length limit, comprising a module shell, a traction rope arranged in the module shell, and a winding mechanism applied to winding the traction rope, wherein the module shell has a gear shifting mechanism arranged, applied to limiting a pulling-out length of the traction rope by restricting a movement of the winding mechanism.

2. The traction module with the adjustable length limit according to claim 1, wherein the winding mechanism comprises a roller arranged in the module shell and a coil spring arranged in the roller, an inner side of the module shell has a fixed shaft arranged, the roller is sleeved on the fixed shaft, and the traction rope is wound and arranged on the roller.

3. The traction module with the adjustable length limit according to claim 2, wherein the gear shifting mechanism comprises a gear shifting connector, a gear shifting disc assembly, and a regulation disc assembly arranged in a sequence, the gear shifting disc assembly connects to the roller through the gear shifting connector, the regulation disc assembly restricts a rolling number of the roller through the gear shifting disc assembly.

4. The traction module with the adjustable length limit according to claim 3, wherein the gear shifting disc assembly comprises a driving ring connecting to the gear shifting connector, and a plurality of driven rings arranged coaxially with the driving ring, the plurality of driven rings and the driving ring are engaged sequentially from outside to inside; the driving ring has a driving block arranged, and each of the plurality of driven rings has a driven block arranged, the driving block and the plurality of driven blocks are stacked in an order from inside to outside.

5. The traction module with the adjustable length limit according to claim 4, wherein the gear shifting connector comprises a spline connected to the roller and a transmission shaft arranged on a side of the spline facing to the gear shifting mechanism, the transmission shaft is inserting and connecting to an inside of the driving ring, while the transmission shaft and the driving ring are rolling coaxially through a connection unit.

6. The traction module with the adjustable length limit according to claim 4, wherein the regulation disc assembly comprises a regulation disc body, a plurality of regulation holes arranged in the regulation disc body, and a regulation pin applied to inserting into the regulation hole, while the plurality of regulation holes are corresponding respectively to the plurality of driven blocks, the regulation pin inserts into one of the regulation holes, applied to blocking a movement of the driven block correspondingly.

7. The traction module with the adjustable length limit according to claim 6, wherein the module shell has an accommodating cavity arranged, applied to accommodating the gear shifting disc assembly, the regulation disc body is arranged covering a front end of the accommodating cavity; a middle part of the regulation disc body has a storage hole arranged, applied to accommodating the regulation pin.

8. The traction module with the adjustable length limit according to claim 2, wherein the module shell further has a brake mechanism arranged, the brake mechanism comprises a support seat arranged on the module shell, a brake block slidably connected to the support seat, and a brake disc arranged on the roller while adapting to the brake block, and a spring is arranged between the brake block and the support seat.

9. The traction module with the adjustable length limit according to claim 8, wherein the brake block comprises a button and a clamping block arranged on the button, the clamping block is arranged at an end of the button facing to the roller, the brake disc is arranged on a side surface of the roller, the brake disc has a plurality of clamping teeth arranged adapting to the clamping block, and the plurality of clamping teeth are arranged evenly on an edge of the brake disc.

10. A pet tractor, wherein comprising the traction module with the adjustable length limit according to any one of claims 1-9, and a tractor shell arranged covering an outside of the traction module.
